(19) United States
(12) Patent Application Publication
(10) Pub. No.: US 2026/0066270 A1
(43) Pub. Date: Mar. 5, 2026

(54) METHOD FOR PREPARING AN AQUEOUS CATHODE SLURRY COMPOSITION

(71) Applicant: REMPLIR INC., Daegu (KR)

(72) Inventors: SOO JIN KIM, Namyangju-si (KR); DONG HYUN KIM, Gunpo-si (KR); CHANG NYON SHIN, Hwaseong-si (KR); HYUN SEOK KO, Cheonan-si (KR); HYUN JIN SHIN, Seoul (KR); DIEKY SUSAN TO LIAU, Hwaseong-si (KR); SEONG GYEOM KIM, Bucheon-si (KR); SOO SUN KIM, Seoul (KR)

(73) Assignee: REMPLIR INC., Daegu (KR)

(21) Appl. No.: 18/821,486

(22) Filed: Aug. 30, 2024

(51) Int. Cl. H01M 4/1397; B01F 23/50; B01F 23/53; B01F 23/57; B01F 27/232; H01M 4/02; H01M 4/04; H01M 4/136; H01M 4/58; H01M 4/62; H01M 10/0525

(52) U.S. Cl. CPC H01M 4/1397; B01F 23/511; B01F 23/53; B01F 23/565; B01F 23/57; B01F 27/2324; H01M 4/0404; H01M 4/043; H01M 4/136; H01M 4/5825; H01M 4/622; H01M 10/0525; H01M 2004/028

(57) ABSTRACT

A method for preparing an aqueous cathode slurry composition, specifically including: (a) performing a first mixing step by mixing a binder and an aqueous solvent; and (b) mixing lithium iron phosphate (LiFePO4) as the cathode active material and a conductive agent into the mixture from step (a), followed by performing a second mixing step using at least one process selected from the group consisting of high rotation energy dispersion mixing, compression pressure mixing, and rotation shear mixing.

### STATEMENT REGARDING GOVERNMENT SPONSORED RESEARCH OR DEVELOPMENT

This invention was made with a government sponsored research under a grant (2023-2324-003) from Gyeonggi Energy Innovation Technology Support Project funded by Gyeonggi Province of the Republic of Korea. The government may have certain rights in the invention.

### BACKGROUND OF THE INVENTION

### Field of the Invention

This invention relates to a method for preparing an aqueous cathode slurry composition for lithium-ion secondary batteries that enhances dispersion and significantly shortens the manufacturing process time.

### Description of the Related Art

The process of coating active materials for cathodes or anodes onto a current collector to create battery electrodes is called the electrode manufacturing process. This process typically involves a mixing stage, where materials such as electrode active material, conductive agent, binder, and solvent are combined to form a slurry. This slurry form is preferred as it can be more easily coated onto the electrode substrate, making it easier to work with. Therefore, for optimal battery performance, the dispersion of the slurry containing active material should be high, and the mixing method should be optimized based on the materials used.

Currently, most cathode slurries for lithium-ion secondary batteries use organic-based slurries with NMP (N-Methyl-2-pyrrolidone) as the solvent. However, due to recent environmental concerns and carbon reduction policies, companies have been exploring various ways to reduce the use of NMP. Some companies have introduced NMP recovery and purification facilities, but there are still major solutions remaining in terms of high operating costs and the need to use NMP again.

As a result, interest is growing in environmentally friendly aqueous mixing slurry production methods that use deionized water, which reduces costs and decreases the use of harmful organic solvents, compared to traditional organic cathode slurry manufacturing.

While the transition from organic-based slurries to aqueous slurries has not been particularly difficult for anodes, there are significant technical barriers in applying aqueous mixing methods to cathode slurries containing lithium oxides.

Key factors in the manufacture of aqueous cathode slurries include selecting suitable active materials that allow for mixing and completing the mixing and coating process quickly.

In the field of aqueous cathode slurries, lithium iron phosphate (LiFePO₄) is commonly selected as the cathode active material. Although structurally stable, lithium iron phosphate has the drawback of low electrical and ionic conductivity. Efforts have been made to improve ionic conductivity by reducing the particle size of lithium iron phosphate to the nano level. However, while reducing particle size to increase the active surface area can facilitate lithium ion movement, smaller particles also lead to stronger aggregation between cathode active material particles, making dispersion difficult and achieving high electrode density challenging.

Furthermore, in the mixing process of aqueous cathode slurries, lithium leaching occurs over time when lithium oxide active materials are mixed with deionized water and an aqueous binder. This lithium leaching changes the pH of the mixture of deionized water and aqueous binder, which leads to rapid changes in physical properties such as viscoelasticity or gelation. Therefore, to enhance the dispersion of the aqueous cathode slurry composition and to minimize aggregation, it is essential to complete the mixing process within a short period.

If materials, especially active materials, are not evenly distributed in the electrode slurry, this will result in non-uniform electrode density, causing a decline in cell performance and degradation.

In conventional methods of mixing aqueous cathode slurries, impellers or PD mixers (Planetary Disperser Mixers) are typically used. However, when the electrode slurry produced in this way is coated on the current collector, poor dispersion of the binder and active material can often be observed in certain areas, leading to reduced cell performance. Additionally, it takes more than 12 hours to achieve the desired slurry viscosity and characteristics.

Therefore, in the field of aqueous cathode slurry production, there is a need for high-dispersion mixing processes that can achieve fast mixing, overcome the gelation of the slurry, and yield dispersion equivalent to that of organic-based cathode slurries.

### SUMMARY OF THE INVENTION

This invention aims to address the above issues by enhancing the dispersion of an aqueous lithium iron phosphate cathode slurry composition. Improved dispersion enables the production of electrodes with a higher density and more uniform dispersion compared to conventional aqueous cathodes, and it significantly shortens the manufacturing process time.

This invention provides a method for preparing an aqueous cathode slurry composition, which includes:

(a) a step of performing a primary mixing process by combining a binder and an aqueous solvent; and (b) a step of performing a secondary mixing process by adding a lithium iron phosphate (LiFePO4) cathode active material and a conductive material to the mixture obtained from step (a). The secondary mixing process is characterized by employing at least one process selected from the group consisting of high rotation energy dispersion mixing, compression pressure mixing, and rotation shear mixing.

According to the method of manufacturing an aqueous cathode slurry composition as provided by this invention, it is possible to improve the dispersion of the aqueous lithium iron phosphate cathode slurry composition. Through enhanced dispersion, it is also possible to produce electrodes with higher density and more uniform dispersion than conventional aqueous cathodes.

Furthermore, the method of manufacturing an aqueous cathode slurry composition as provided by this invention significantly shortens the manufacturing process time for aqueous cathode slurry compositions, which helps to suppress the gelation of the slurry during production and further increases the productivity of aqueous electrodes.

### BRIEF DESCRIPTION OF THE DRAWINGS

FIG. 1 shows scanning electron microscope (SEM) measurement data for electrodes prepared using the cathode slurry compositions of the present invention's embodiment, Comparative Example 1, and Comparative Example 2.

FIG. 2 relates to a graph displaying the initial battery capacity measurement results for cells (coin cells) prepared using the cathode slurry compositions of the present invention's embodiment, Comparative Example 1, and Comparative Example 2.

### DETAILED DESCRIPTION OF THE INVENTION

This invention can be subject to various modifications and can take numerous embodiments. Specific embodiments are illustrated in the drawings and described in detail to provide a comprehensive explanation, but they are not intended to limit the invention to specific forms. All modifications, equivalents, and substitutes included within the spirit and scope of the invention should be understood to be encompassed within it. If detailed descriptions of well-known technologies related to the invention might obscure the essence of the invention, they are omitted.

The terminology used in this application is employed merely to describe particular embodiments and not to limit the invention. Singular expressions include plural forms unless otherwise clearly indicated by context. Terms such as “comprise” or “have” are intended to specify that features, numbers, steps, actions, components, parts, or combinations thereof described in the specification exist without excluding the possibility of other features or components.

This invention relates to a method for preparing an aqueous cathode slurry composition, specifically involving:
(a) a step of performing a primary mixing process by combining a binder and an aqueous solvent; and (b) a step of performing a secondary mixing process by adding a lithium iron phosphate (LiFePO4) cathode active material and a conductive material to the mixture obtained from step (a). The secondary mixing process is characterized by employing at least one process selected from the group consisting of high rotation energy dispersion mixing, compression pressure mixing, and rotation shear mixing.

In this invention, step (a) is performed by mixing the binder and aqueous solvent from the raw materials of the cathode slurry composition. It is preferable to use an aqueous binder in this step, as the aqueous binder can achieve point or line contact with a specific amount of lithium iron phosphate active material, thus increasing adhesion even with a small amount and allowing for a relatively higher content of the active material in the electrode. This can increase the battery capacity and enhance various performance characteristics of the battery, such as cycle life and output characteristics.

The aqueous binder may be selected from the group consisting of acrylonitrile butadiene rubber, styrene-butadiene rubber, acrylic rubber, hydroxyethyl cellulose, carboxymethyl cellulose, and acrylate-based polymers. More preferably, it may be an acrylate-based polymer.

The acrylate-based polymer may be a polymer of one or more monomers selected from the group consisting of methacryloxyethyl ethylene urea, β-carboxyethyl acrylate, aliphatic monoacrylate, dipropylene diacrylate, ditrimethylolpropane tetraacrylate, hydroxyethyl acrylate, dipentaerythritol hexaacrylate, pentaerythritol triacrylate, pentaerythritol tetraacrylate, lauryl acrylate, ceryl acrylate, stearyl acrylate, lauryl methacrylate, ceryl methacrylate, and stearyl methacrylate.

The content of the binder is not particularly limited but is preferably included in an amount of 1 to 15 weight % based on the total weight of the cathode slurry composition, and more preferably, 1 to 10 weight %. If the binder content is less than 1 weight % of the total weight of the cathode slurry composition, the adhesion of the active material to the current collector is weakened, which can lead to peeling off during the drying process after coating the electrode slurry, making it difficult to assemble the battery and reducing the cycle life of the battery. Conversely, if the binder content exceeds 15 weight % of the total weight of the cathode slurry composition, the excessive binder content may reduce the amount of active material, lowering the capacity of the battery. It can also increase the viscosity of the slurry excessively, inhibiting the dispersion of the active material particles, leading to non-uniform electrode performance, and causing difficulty in achieving a uniform coating on the current collector.

The aqueous solvent is not particularly limited; however, to minimize ionic contamination and improve the dispersion of the binder for ensuring uniformity of the cathode slurry composition, deionized water is preferable.

The first mixing process may utilize a commonly used mixing process, for example, a mixing process using a PD mixer (Planetary Disperser Mixer).

In the second mixing step (b), lithium iron phosphate (LiFePO4) as the cathode active material and a conductive agent are mixed into the mixture from step (a), and this step utilizes one or more processes selected from high rotation energy dispersion mixing, compression pressure mixing, and rotational shear mixing. This approach enhances the dispersion of the aqueous lithium iron phosphate cathode slurry composition, allowing for the manufacture of electrodes with uniform dispersion and high density compared to conventional aqueous cathodes, and significantly shortening the manufacturing process time for the aqueous cathode slurry composition. This effectively suppresses the gelation phenomenon of the slurry during production, thereby improving productivity for aqueous electrodes.

The second mixing process preferably utilizes two or more processes selected from the group consisting of high rotation energy dispersion mixing, compression pressure mixing, and rotational shear mixing to further enhance the dispersion of the aqueous lithium iron phosphate cathode slurry composition and shorten the manufacturing process time.

High rotation energy dispersion mixing (HREDM) involves a mixing container that rotates at very high speeds, performing both rotation and revolution. This process ensures uniform distribution and mixing of materials based on their weight and density within the slurry composition. The strong rotational force generated by high-speed rotation helps mix the materials uniformly and disperse them into fine particles.

Compression pressure mixing (CPM) is a mixing process where pressure is applied to the materials, primarily used to uniformly mix high-viscosity or high-density materials. The compression force helps densify the materials and facilitates their combination and mutual collision and grinding processes, aiding in the production of high-density and highly dispersed electrodes.

Rotational shear mixing (RSM) is a mixing process that utilizes shear forces generated by rotation to mix materials. The rotating mixer tool draws in and expels the material while applying high shear forces, breaking the materials down and ensuring uniform mixing.

In this invention, the lithium iron phosphate (LiFePO4) cathode active material may have a carbon-based material coated on its surface to enhance electrical conductivity. The content of the lithium iron phosphate (LiFePO4) cathode active material is not particularly limited, but it is preferably included in an amount of 70 to 98 weigh t% based on the total weight of the cathode slurry composition, and more preferably, 75 to 95 weight %.

The conductive agent used in this invention serves to impart conductivity to the electrode and can be used without special limitations as long as it does not induce chemical changes during the charge and discharge processes of lithium-ion secondary batteries. Examples include conductive materials from graphite sources such as natural or synthetic graphite; carbon blacks such as carbon black, acetylene black, and ketjen black; and conductive materials such as carbon fibers, carbon nanotubes (CNT), graphene, or similar nano-carbons. The conductive agent may be included in an amount of 1 to 10 weight % based on the total weight of the cathode slurry composition.

Another aspect of this invention relates to an aqueous cathode slurry composition for lithium-ion secondary batteries, which is characterized by being manufactured according to the manufacturing method described above.

A further aspect of this invention may be an aqueous cathode manufactured by coating, drying, and pressing the aforementioned aqueous cathode slurry composition onto a current collector, and it may also include a lithium-ion secondary battery that incorporates the aforementioned cathode.

According to the method for producing the aqueous cathode slurry composition provided by this invention, it is possible to improve the dispersion of the aqueous lithium iron phosphate cathode slurry composition. Enhanced dispersion allows for the production of electrodes with higher density and more uniform dispersion compared to conventional aqueous cathodes, achieving slurry properties equivalent to those of organic-based cathode slurry compositions.

Additionally, according to the manufacturing method provided by this invention, the manufacturing process time for the aqueous cathode slurry composition can be significantly reduced to about one-third of existing levels. This helps suppress the gelation phenomenon of the slurry during production and improves the productivity of aqueous electrodes.

The following examples illustrate the invention. These examples are merely illustrative of the invention and are not intended to limit the scope of the invention.

### EXAMPLE

First, 7 wt % of acrylonitrile butadiene rubber was mixed with deionized water to achieve a total designed solid content of 50 wt % in the slurry, followed by performing the first mixing process for one hour using a PD mixer (Planetary Disperser Mixer).

Afterwards, 90 wt % of lithium iron phosphate (LiFePO4) as the cathode active material and 3 wt % of a conductive agent (carbon black) were mixed, and a second mixing process was performed to produce the aqueous cathode slurry composition according to the embodiment of the invention.

In this case, the second mixing process was conducted using a compression pressure mixer, setting the mixer pressure to 50-150 psi and mixing for two hours. After that, a high rotation energy dispersion mixer was used, setting the rotation speed of the mixer to 180-240 rpm and mixing for two hours.

### Comparative Example 1

7 wt % of acrylonitrile butadiene rubber was mixed with deionized water to achieve a total designed solid content of 50 wt % in the slurry, followed by performing the first mixing process for one hour using a PD mixer (Planetary Disperser Mixer).

Afterwards, 90 wt % of lithium iron phosphate (LiFePO4) as the cathode active material and 3 wt % of a conductive agent (carbon black) were mixed, followed by performing a second mixing process for four hours using a PD mixer to produce the aqueous cathode slurry composition according to the comparative example.

### Comparative Example 2

7 wt % of PVDF (Polyvinylidene fluoride), which is one of the organic polymer binders, was mixed with NMP (N-Methyl-2-pyrrolidone) to achieve a total designed solid content of 50 wt % in the slurry, followed by performing the first mixing process for one hour using a PD mixer (Planetary Disperser Mixer).

Afterwards, 90 wt % of lithium iron phosphate (LiFePO4) as the cathode active material and 3 wt % of a conductive agent (carbon black) were mixed, followed by performing a second mixing process for four hours using a PD mixer to produce the organic-based cathode slurry composition according to the comparative example.

### Experimental Example 1: Dispersion State of the Electrode

The aqueous cathode slurry compositions of the above Example, Comparative Example 1, and Comparative Example 2 were coated, dried, and pressed onto one side of an aluminum current collector to produce each cathode electrode.

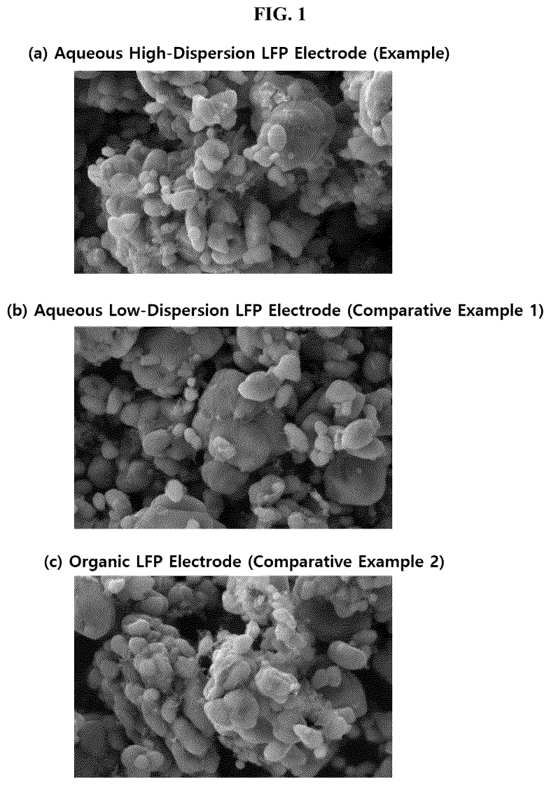

The dispersion state of the electrodes was examined using a Scanning Electron Microscope (SEM), and the results are shown in FIG. 1.

According to FIG. 1, the aqueous LFP electrode (a) of the invention's example exhibited a higher dispersion state than the aqueous LFP electrode (b) of Comparative Example 1 and was confirmed to have a dispersion state equivalent to that of the organic-based LFP electrode (c) of Comparative Example 2.

### Experimental Example 2: Initial Battery Capacity

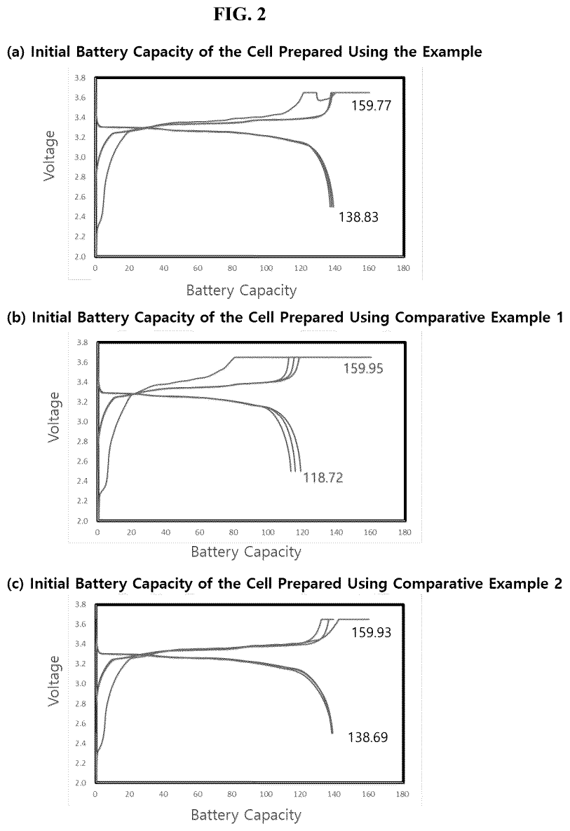

Using each cathode electrode manufactured in Experimental Example 1, coin half-cells were fabricated under the same conditions with lithium metal on one side, and the initial battery capacity was measured. The results are shown in the graph of FIG. 2.

According to FIG. 2, the battery (a) manufactured using the aqueous LFP electrode of the invention's example exhibited a higher initial battery capacity compared to the battery (b) manufactured using the aqueous LFP electrode of Comparative Example 1, and showed an initial battery capacity equivalent to that of the battery (c) manufactured using the organic-based LFP electrode of Comparative Example 2.

As described above, those skilled in the art will understand that this invention can be implemented in other specific forms without changing its technical spirit or essential features. The scope of this invention is indicated by the appended claims rather than the detailed description above, and all modifications or variations derived from the meaning, scope, and equivalents of the claims should be understood to be included within the scope of the invention.

What is claimed is:

1. A method for preparing an aqueous cathode slurry composition, comprising:
(a) performing a first mixing step by mixing a binder and an aqueous solvent; and
(b) mixing lithium iron phosphate (LiFePO4) as a cathode active material and a conductive agent into a mixture from step (a), followed by performing a second mixing step using at least one process selected from the group consisting of high rotation energy dispersion mixing, compression pressure mixing, and rotation shear mixing.

2. The method of claim 1, wherein the binder is an aqueous binder.

3. The method of claim 2, wherein the aqueous binder is selected from the group consisting of acrylonitrile butadiene rubber, styrene-butadiene rubber, acrylic rubber, hydroxyethyl cellulose, carboxymethyl cellulose, and acrylate-based polymers.

4. The method of claim 1, wherein the binder is included in an amount of 1 to 15 weight % based on a total weight of the aqueous cathode slurry composition.

5. The method of claim 1, wherein the aqueous solvent is deionized water.

6. The method of claim 1, wherein the first mixing step is performed using a PD mixer (Planetary Disperser Mixer).

7. The method of claim 1, wherein the lithium iron phosphate (LiFePO4) cathode active material is included in an amount of 70 to 98 weight % based on a total weight of the aqueous cathode slurry composition.

8. The method of claim 1, wherein the conductive agent is included in an amount of 1 to 10 weight % based on a total weight of the aqueous cathode slurry composition.

9. An aqueous cathode slurry composition for lithium-ion secondary batteries manufactured by the method of claim 1.

10. A lithium-ion secondary battery cathode manufactured by coating, drying, and pressing the aqueous cathode slurry composition of claim 9 onto a current collector.

11. A lithium-ion secondary battery comprising the lithium-ion secondary battery cathode of claim 10.
